(19) United States
(12) Patent Application Publication
(10) Pub. No.: US 2015/0230325 A1
(43) Pub. Date: Aug. 13, 2015

(54) METHODS AND APPARATUS FOR LASER PRODUCED PLASMA EUV LIGHT SOURCE

(71) Applicant: CYMER, LLC, San Diego, CA (US)

(72) Inventor: Vladimir B. Fleurov, Escondido, CA (US)

(73) Assignee: CYMER, LLC, San Diego, CA (US)

(21) Appl. No.: 14/177,057

(22) Filed: Feb. 10, 2014

(51) Int. Cl. H05G 2/00

(52) U.S. Cl. CPC H05G 2/006; H05G 2/008

(57) ABSTRACT

A system for producing EUV light using a drive laser beam to irradiate a stream of material droplets. There is included a monitoring system for monitoring at least one of drive laser beam reflection from the drive laser beam and EUV radiation pulses and producing a detector signal, the detector signal being a pulse train. There is also included an arrangement for analyzing the detector signal to ascertain whether there exists at least one satellite droplet in the stream of material droplets.

### FIELD OF THE INVENTION

The present disclosure relates to extreme ultraviolet (“EUV”) light sources that provide EUV light from a plasma that is created from a target material and collected and directed to an intermediate region for utilization outside of the EUV light source chamber, e.g., by a lithography scanner/stepper.

### BACKGROUND

Extreme ultraviolet light, e.g., electromagnetic radiation having wavelengths of around 50 nm or less (also sometimes referred to as soft x-rays), and including light at a wavelength of about 13.5 nm, can be used in photolithography processes to produce extremely small features in substrates, e.g., silicon wafers.

Methods to produce EUV light include, but are not necessarily limited to, converting a material into a plasma state that has at least one element, e.g., xenon, lithium or tin, with one or more emission line in the EUV range. In one such method, often termed laser produced plasma (“LPP”) the required plasma can be produced by irradiating a target material having the required line-emitting element, with a laser beam.

In an example arrangement, LPP light sources generate EUV radiation by depositing laser energy into a source element, such as xenon (Xe), tin (Sn) or lithium (Li), creating a highly ionized plasma with electron temperatures of several 10's of eV. The energetic radiation generated during de-excitation and recombination of these ions is emitted from the plasma in all directions. In one common arrangement, a near-normal-incidence mirror (often termed a “collector mirror”) is positioned at a distance from the plasma to collect, direct (and in some arrangements, focus) the light to an intermediate location, e.g., focal point. The collected light may then be relayed from the intermediate location to a set of scanner optics and ultimately to a wafer. In more quantitative terms, one arrangement that is currently being developed with the goal of producing up to about 100 W of EUV power at the intermediate location contemplates the use of a pulsed, focused 10-12 kW CO₂ drive laser which is synchronized with a droplet generator to sequentially irradiate about 40,000-100,000 tin droplets per second. For this purpose, there is a need to produce a stable stream of droplets at a relatively high repetition rate (e.g., 40-100 kHz or more) and deliver the droplets to an irradiation site with high accuracy and good repeatability in terms of timing and position (i.e. with very small “jitter”) over relatively long periods of time.

For a typical LPP setup, target material droplets are generated and then travel within a vacuum chamber to an irradiation site where they are irradiated, e.g. by a focused laser beam.

One technique for generating droplets involves melting a target material, e.g., tin, and then forcing it under high pressure through a relative small diameter orifice, e.g. 0.5-30 μm. Under most conditions, naturally occurring instabilities, e.g. noise, in the stream exiting the orifice may cause the stream to break-up into droplets. In order to synchronize the droplets with optical pulses of the LPP drive laser, a repetitive disturbance with an amplitude exceeding that of the random noise may be applied to the continuous stream. By applying a disturbance at the same frequency (or its higher harmonics) as the repetition rate of the pulsed laser, the droplets can be synchronized with the laser pulses.

If the repetitive disturbance signal has a single frequency, a micro-droplet is produced for each period of the disturbance waveform. To cause multiple micro-droplets to coalesce together into a larger droplet, the disturbance signal may be modulated and may employ multiple characteristic frequencies. For example, the disturbance waveform may include a main carrier frequency and one or more modulation frequencies, which is/are typically smaller than the main carrier frequency. An example modulation frequency may be implemented using a harmonic of the carrier frequency (such as for example a third of the carrier frequency). The modulation frequency/frequencies causes different micro-droplets to depart the nozzle at different velocities, thereby causing them to coalesce after exiting the nozzle.

In an example, a plurality of micro-droplets, such as 60 micro-droplets, may coalesce together to form a larger main droplet. The stream of main droplets may then be irradiated by pulses from the main drive laser beam (which may involve one or more main pulses and optionally one or more pre-pulses for each main droplet) to create the aforementioned plasma.

If some of the micro-droplets do not coalesce into a larger droplet, the stream of droplets may include both the larger main droplets and some micro-droplets that failed to coalesce. The existence of the micro-droplets that failed to coalesce (so-called “satellite droplets”) in the droplet stream represents a non-optimal situation.

For one, the main droplets are optimally sized to generate the desired EUV radiation. The presence of satellite droplets, i.e., micro-droplets that failed to coalesce, means that one or more of the main droplets lack optimal size/mass/shape for optimal irradiation. Further, if the micro-droplets are irradiated, some of the laser energy that should be directed toward the main droplets is instead diverted to these undesirable satellite droplets, resulting in reduced system performance. Additionally, the irradiation of satellite droplets in the stream of main droplets creates unwanted plasma and may cause unintended instability in the droplet stream.

For these and other reasons, it is desirable to detect the presence of satellite droplets. The present invention relates to methods and apparatuses for such detection.

### SUMMARY

The invention relates in one or more embodiments to a system for producing EUV light using a drive laser beam to irradiate a stream of material droplets. There is included a monitoring system for monitoring at least one of drive laser beam reflection from the drive laser beam and EUV radiation pulses and producing a detector signal, the detector signal being a pulse train. There is also included an arrangement for analyzing the detector signal to ascertain whether there exists at least one satellite droplet in the stream of material droplets.

In an embodiment, the reflection from the drive laser beam is monitored. In another embodiment, the EUV radiation pulses are monitored.

### BRIEF DESCRIPTION OF THE DRAWINGS

FIG. 1 shows a simplified, schematic view of a laser produced plasma EUV light source;

FIG. 2 shows a schematic a simplified droplet source;

FIGS. 2A-2D illustrate several different techniques for coupling an electro-actuable element with a fluid to create a disturbance in a stream exiting an orifice;

FIG. 3 (Prior Art) illustrates the pattern of droplets resulting from a single frequency, non-modulated disturbance waveform;

FIG. 4 illustrates the pattern of droplets resulting from an amplitude modulated disturbance waveform;

FIG. 5 illustrates the pattern of droplets resulting from a frequency modulated disturbance waveform;

FIG. 6 shows a droplet stream comprising a plurality of main droplets.

FIG. 7 shows an example of NOMO temporal pulse wherein the micro-droplets coalesce into the main droplets in the absence of satellite droplets.

FIG. 8 shows an example of NOMO temporal pulse train wherein the micro-droplets coalesce into a main droplet and a satellite droplet.

FIG. 9 shows an example NOMO temporal pulse train wherein the micro-droplets coalesce into a main droplet and a plurality of satellite droplets.

FIG. 10A shows an example plot of EUV pulse-to-pulse interval (Y axis) versus pulse count (X axis) for the situation where no satellite droplets exist.

FIG. 10B shows an example plot of EUV pulse-to-pulse interval (Y axis) versus pulse count (X axis) for the situation where there are satellite droplets in addition to the main droplets in the droplet stream.

FIG. 11A shows the histogram plot for the example of FIG. 10A where no satellite droplets exist. The Y axis represents the bin count, and the X axis represents the time. A well-defined set of peaks 1102 clustered around the 250 μs mark represents the EUV pulses detected at around the 250 μs interval.

FIG. 11B shows the histogram plot for the example of FIG. 10B where satellite droplets are detected.

FIG. 12 shows, in accordance with an embodiment of the invention, a method for detecting satellite droplets using reflection of the main drive laser beam.

FIG. 13 shows, in accordance with an embodiment of the invention, a method for detecting satellite droplets using EUV peak detection.

### DETAILED DESCRIPTION

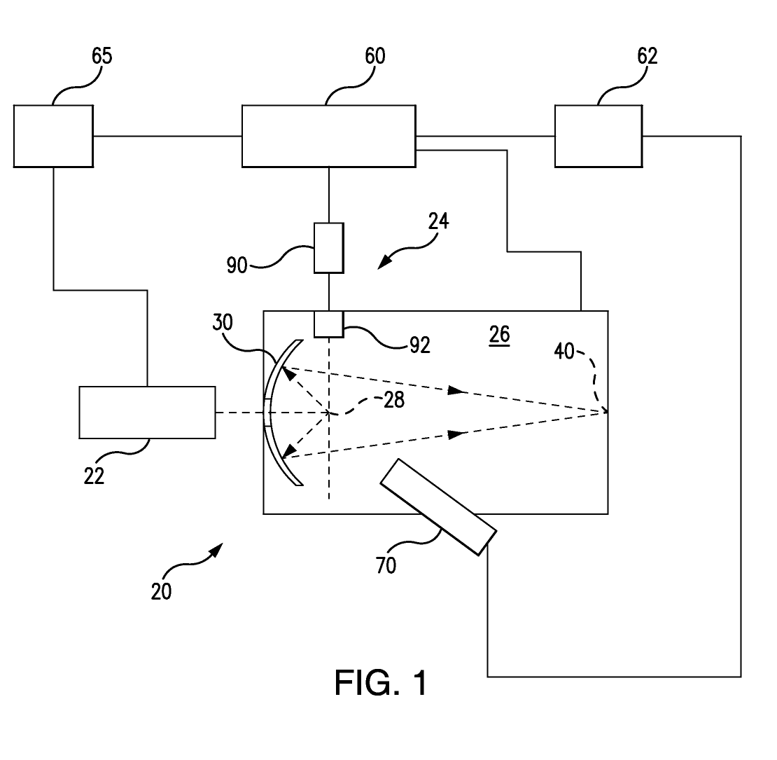

With initial reference to FIG. 1, there is shown a schematic view of an EUV light source, e.g., a laser-produced-plasma, EUV light source 20 according to one aspect of an embodiment. As shown in FIG. 1, and described in further detail below, the LPP light source 20 may include a system 22 for generating a train of light pulses and delivering the light pulses into a chamber 26. As detailed below, each light pulse may travel along a beam path from the system 22 and into the chamber 26 to illuminate a respective target droplet at an irradiation region 28.

Suitable lasers for use as the system 22 shown in FIG. 1 may include a pulsed laser device, e.g., a pulsed gas discharge CO₂ laser device producing radiation at 9.3 μm or 10.6 μm, e.g., with DC or RF excitation, operating at relatively high power, e.g., 10 kW or higher and high pulse repetition rate, e.g., 50 kHz or more. In one particular implementation, the laser may be an axial-flow RF-pumped CO₂ laser having a MOPA configuration with multiple stages of amplification and having a seed pulse that is initiated by a Q-switched Master Oscillator (MO) with low energy and high repetition rate, e.g., capable of 100 kHz operation. From the MO, the laser pulse may then be amplified, shaped, and/or focused before entering the LPP chamber. Continuously pumped CO₂ amplifiers may be used for the system 22. For example, a suitable CO₂ laser device having an oscillator and three amplifiers (O-PA1-PA2-PA3 configuration) is disclosed in U.S. patent application Ser. No. 11/174,299 filed on Jun. 29, 2005, entitled, LPP EUV LIGHT SOURCE DRIVE LASER SYSTEM, Attorney Docket Number 2005-0044-01, the entire contents of which have been previously incorporated by reference herein. Alternatively, the laser may be configured as a so-called “self-targeting” laser system in which the droplet serves as one mirror of the optical cavity. In some “self-targeting” arrangements, a master oscillator may not be required (also known as “NOMO” or “No Master Oscillator”). Self-targeting laser systems are disclosed and claimed in U.S. patent application Ser. No. 11/580,414, filed on Oct. 13, 2006 entitled, DRIVE LASER DELIVERY SYSTEMS FOR EUV LIGHT SOURCE, Attorney Docket Number 2006-0025-01, the entire contents of which have been previously incorporated by reference herein.

Depending on the application, other types of lasers may also be suitable, e.g., an excimer or molecular fluorine laser operating at high power and high pulse repetition rate. Examples include, a solid state laser, e.g., having a fiber or disk shaped active media, an excimer laser having one or more chambers, e.g., an oscillator chamber and one or more amplifying chambers (with the amplifying chambers in parallel or in series), a master oscillator/power oscillator (MOPO) arrangement, a power oscillator/power amplifier (POPA) arrangement, or a solid state laser that seeds one or more excimer or molecular fluorine amplifier or oscillator chambers, may be suitable. Other designs are possible.

As further shown in FIG. 1, the EUV light source 20 may also include a target material delivery system 24, e.g., delivering droplets of a target material into the interior of a chamber 26 to the irradiation region 28 where the droplets will interact with one or more light pulses, e.g., zero, one or more pre-pulses and thereafter one or more main pulses, to ultimately produce a plasma and generate an EUV emission. The target material may include, but is not necessarily limited to, a material that includes tin, lithium, xenon or combinations thereof. The EUV emitting element, e.g., tin, lithium, xenon, etc., may be in the form of liquid droplets and/or solid particles contained within liquid droplets. For example, the element tin may be used as pure tin, as a tin compound, e.g., SnBr₄, SnBr₂, SnH₄, as a tin alloy, e.g., tin-gallium alloys, ting indium alloys, tin-indium-gallium alloys, or a combination thereof. Depending on the material used, the target material may be presented to the irradiation region 28 at various temperatures including room temperature or near room temperature (e.g., tin alloys, SnBr₄) at an elevated temperature, (e.g., pure tin) or at temperatures below room temperature, (e.g., SnH₄), and in some cases, can be relatively volatile, e.g., SnBr₄. More details concerning the use of these materials in an LPP EUV source is provided in U.S. patent application Ser. No. 11/406,216, filed on Apr. 17, 2006, entitled ALTERNATIVE FUELS FOR EUV LIGHT SOURCE, Attorney Docket Number 2006-0003-01, the contents of which have been previously incorporated by reference herein.

Continuing with FIG. 1, the EUV light source 20 may also include an optic 30, e.g., a collector mirror in the form of a truncated ellipsoid having, e.g., a graded multi-layer coating with alternating layers of Molybdenum and Silicon. FIG. 1 shows that the optic 30 may be formed with an aperture to allow the light pulses generated by the system 22 to pass through and reach the irradiation region 28. As shown, the optic 30 may be, e.g., an ellipsoidal mirror that has a first focus within or near the irradiation region 28, and a second focus at a so-called intermediate region 40, where the EUV light may be output from the EUV light source 20 and input to a device utilizing EUV light, e.g., an integrated circuit lithography tool (not shown). It is to be appreciated that other optics may be used in place of the ellipsoidal mirror for collecting and directing light to an intermediate location for subsequent delivery to a device utilizing EUV light, for example, the optic may be parabolic or may be configured to deliver a beam having a ring-shaped cross-section to an intermediate location, see e.g. U.S. patent application Ser. No. 11/505,177 filed on Aug. 16, 2006, entitled EUV OPTICS, Attorney Docket Number 2006-0027-01, the contents of which are hereby incorporated by reference.

Continuing with reference to FIG. 1, the EUV light source 20 may also include an EUV controller 60, which may also include a firing control system 65 for triggering one or more lamps and/or laser devices in the system 22 to thereby generate light pulses for delivery into the chamber 26. The EUV light source 20 may also include a droplet position detection system which may include one or more droplet imagers 70 that provide an output indicative of the position of one or more droplets, e.g., relative to the irradiation region 28. The imager(s) 70 may provide this output to a droplet position detection feedback system 62, which can, e.g., compute a droplet position and trajectory, from which a droplet error can be computed, e.g., on a droplet-by-droplet basis, or on average. The droplet error may then be provided as an input to the controller 60, which can, for example, provide a position, direction and/or timing correction signal to the system 22 to control a source timing circuit and/or to control a beam position and shaping system, e.g., to change the location and/or focal power of the light pulses being delivered to the irradiation region 28 in the chamber 26.

The EUV light source 20 may include one or more EUV metrology instruments for measuring various properties of the EUV light generated by the source 20. These properties may include, for example, intensity (e.g., total intensity or intensity within a particular spectral band), spectral bandwidth, polarization, beam position, pointing, etc. For the EUV light source 20, the instrument(s) may be configured to operate while the downstream tool, e.g., photolithography scanner, is on-line, e.g., by sampling a portion of the EUV output, e.g., using a pickoff mirror or sampling “uncollected” EUV light, and/or may operate while the downstream tool, e.g., photolithography scanner, is off-line, for example, by measuring the entire EUV output of the EUV light source 20.

As further shown in FIG. 1, the EUV light source 20 may include a droplet control system 90, operable in response to a signal (which, in some implementations may include the droplet error described above, or some quantity derived therefrom) from the controller 60, to e.g., modify the release point of the target material from a droplet source 92 and/or modify droplet formation timing, to correct for errors in the droplets arriving at the desired irradiation region 28 and/or synchronize the generation of droplets with the pulsed laser system 22.

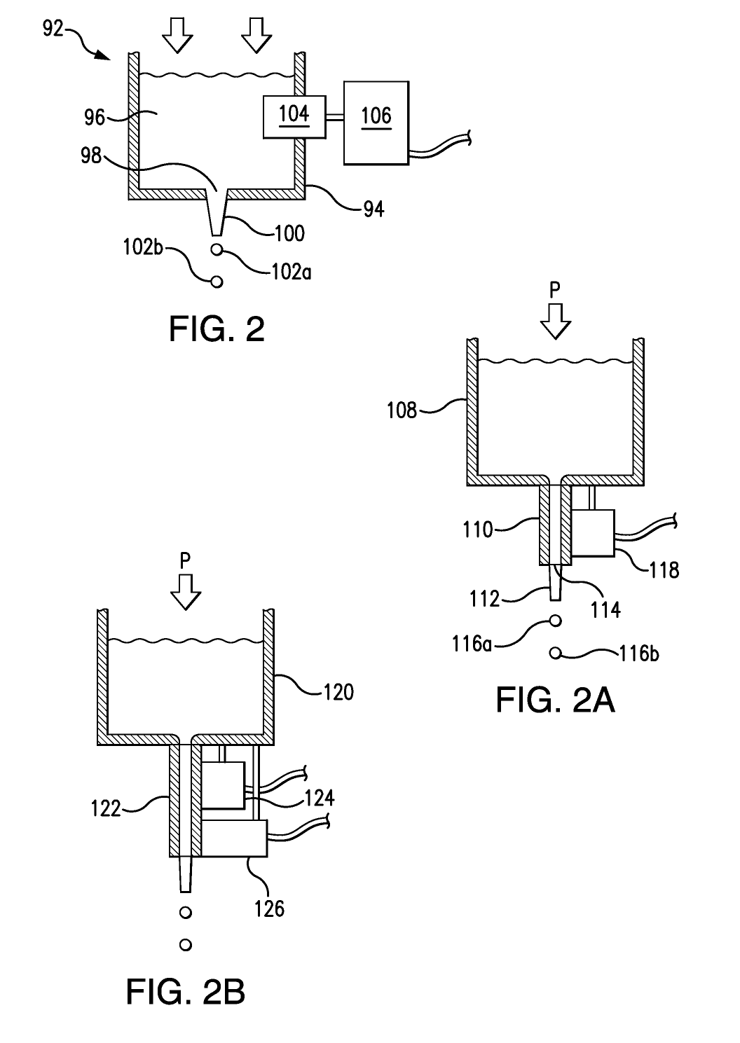

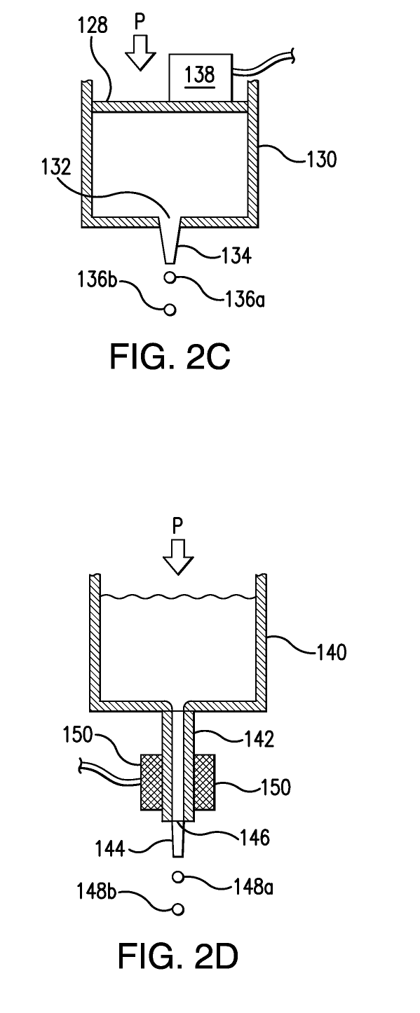

FIG. 2 illustrates the components of a simplified droplet source 92 in schematic format. As shown there, the droplet source 92 may include a reservoir 94 holding a fluid, e.g. molten tin, under pressure. Also shown, the reservoir 94 may be formed with an orifice 98 allowing the pressurized fluid 96 to flow through the orifice establishing a continuous stream 100 which subsequently breaks into a plurality of droplets 102a, b.

Continuing with FIG. 2, the droplet source 92 shown further includes a sub-system producing a disturbance in the fluid having an electro-actuatable element 104 that is operably coupled with the fluid 96 and a signal generator 106 driving the electro-actuatable element 104. FIGS. 2A-2D show various ways in which one or more electro-actuatable elements may be operably coupled with the fluid to create droplets. Beginning with FIG. 2A, an arrangement is shown in which the fluid is forced to flow from a reservoir 108 under pressure through a tube 110, e.g., capillary tube, having an inside diameter between about 0.5-0.8 mm, and a length of about 10 to 50 mm, creating a continuous stream 112 exiting an orifice 114 of the tube 110 which subsequently breaks up into droplets 116a,b. As shown, an electro-actuatable element 118 may be coupled to the tube. For example, an electro-actuatable element may be coupled to the tube 110 to deflect the tube 110 and disturb the stream 112. FIG. 2B shows a similar arrangement having a reservoir 120, tube 122 and a pair of electro-actuatable elements 124, 126, each coupled to the tube 122 to deflect the tube 122 at a respective frequency. FIG. 2C shows another variation in which a plate 128 is positioned in a reservoir 130 moveable to force fluid through an orifice 132 to create a stream 134 which breaks into droplets 136a,b. As shown, a force may be applied to the plate 128 and one or more electro-actuatable elements 138 may be coupled to the plate to disturb the stream 134. It is to be appreciated that a capillary tube may be used with the embodiment shown in FIG. 2C. FIG. 2D shows another variation, in which a fluid is forced to flow from a reservoir 140 under pressure through a tube 142 creating a continuous stream 144, exiting an orifice 146 of the tube 142, which subsequently breaks-up into droplets 148a,b. As shown, an electro-actuatable element 150, e.g., having a ring-like shape, may be positioned around the tube 142. When driven, the electro-actuatable element 142 may selectively squeeze and/or un-squeeze the tube 142 to disturb the stream 144. It is to be appreciated that two or more electro-actuatable elements may be employed to selectively squeeze the tube 142 at respective frequencies.

More details regarding various droplet dispenser configurations and their relative advantages may be found in U.S. patent application Ser. No. 11/358,988, filed on Feb. 21, 2006, entitled LASER PRODUCED PLASMA EUV LIGHT SOURCE WITH PRE-PULSE, Attorney Docket Number 2005-0085-01; U.S. patent application Ser. No. 11/067,124 filed on Feb. 25, 2005, entitled METHOD AND APPARATUS FOR EUV PLASMA SOURCE TARGET DELIVERY, Attorney Docket Number 2004-0008-01; and U.S. patent application Ser. No. 11/174,443 filed on Jun. 29, 2005, entitled LPP EUV PLASMA SOURCE MATERIAL TARGET DELIVERY SYSTEM, Attorney Docket Number 2005-0003-01; the contents of each of which are hereby incorporated by reference.

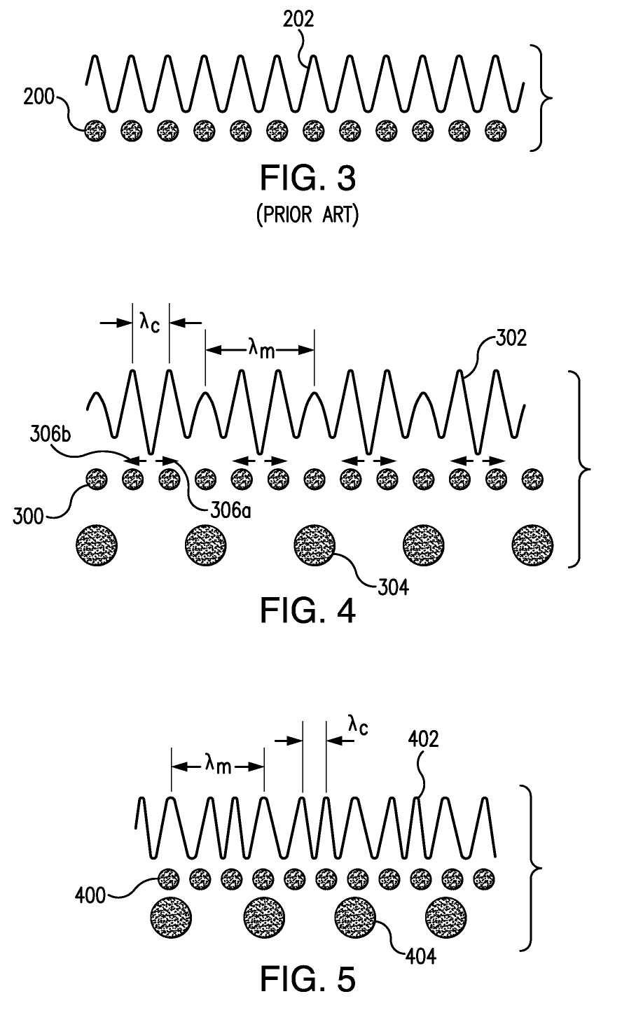

FIG. 3 (Prior Art) illustrates the pattern of droplets 200 resulting from a single frequency, sine wave disturbance waveform 202 (for disturbance frequencies above about 0.3 υ(πd) wherein υ is the stream velocity and d is the diameter of the continuous liquid stream). It can be seen that each period of the disturbance waveform produces a droplet. FIG. 3 also illustrates that the droplets do not coalesce together, but rather, each droplet is established with the same initial velocity.

FIG. 4 illustrates the pattern of droplets 300 initially resulting from an amplitude modulated disturbance waveform 302, which however is unlike the disturbance waveform 202 described above, in that it is not limited to disturbance frequencies above about 0.3 υ/(πd)). It can be seen that the amplitude modulated waveform disturbance 302 includes two characteristic frequencies, a relatively large frequency, e.g., carrier frequency, corresponding to wavelength λ_{c}, and a smaller frequency, e.g., modulation frequency, corresponding to wavelength, λₘ. For the specific disturbance waveform example shown in FIG. 4, the modulation frequency is a carrier frequency subharmonic, and in particular, the modulation frequency is a third of the carrier frequency. With this waveform, FIG. 4 illustrates that each period of the disturbance waveform corresponding to the carrier wavelength, λ_{c} produces a droplet. FIG. 4 also illustrates that the droplets coalesce together, resulting in a stream of larger droplets 304, with one larger droplet for each period of the disturbance waveform corresponding to the modulation wavelength, λₘ. Arrows 306a,b show the initial relative velocity components that are imparted on the droplets by the modulated waveform disturbance 302, and are responsible for the droplet coalescence.

FIG. 5 illustrates the pattern of droplets 400 initially resulting from a frequency modulated disturbance waveform 402, which, like the disturbance waveform 302 described above, is not limited to disturbance frequencies above about 0.3 υ/(πd). It can be seen that the frequency modulated waveform disturbance 402 includes two characteristic frequencies, a relatively large frequency, e.g. carrier frequency, corresponding to wavelength λ_{c}, and a smaller frequency, e.g. modulation frequency, corresponding to wavelength, λₘ. For the specific disturbance waveform example shown in FIG. 5, the modulation frequency is a carrier frequency harmonic, and in particular, the modulation frequency is a third of the carrier frequency. With this waveform, FIG. 5 illustrates that each period of the disturbance waveform corresponding to the carrier wavelength, λ_{c} produces a droplet. FIG. 5 also illustrates that the droplets coalesce together, resulting in a stream of larger droplets 404, with one larger droplet for each period of the disturbance waveform corresponding to the modulation wavelength, λₘ. Like the amplitude modulated disturbance (i.e., FIG. 4), initial relative velocity components are imparted on the droplets by the frequency modulated waveform disturbance 402, and are responsible for the droplet coalescence.

Although FIGS. 4 and 5 show and discuss embodiments having two characteristic frequencies, with FIG. 4 illustrating an amplitude modulated disturbance having two characteristic frequencies, and FIG. 5 illustrating a frequency modulated disturbance having two frequencies, it is to be appreciated that more than two characteristic frequencies may be employed and that the modulation may be either angular modulation (i.e., frequency or phase modulation), amplitude modulation, or combinations thereof.

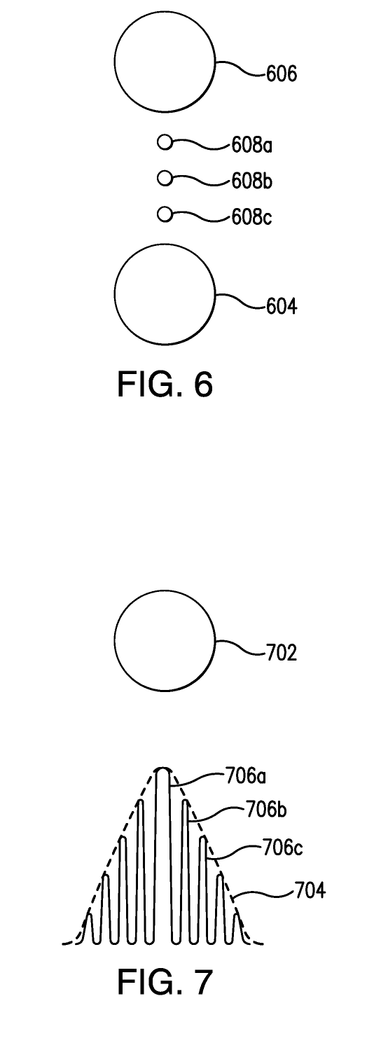

FIG. 6 shows a droplet stream 602 comprising main droplets 604 and 606. A plurality of satellite droplets 608a, 608b, 608c (i.e., micro-droplets that failed to coalesce into one or more of the main droplets) is also shown. The satellite droplets shown are only examples and may lead or lag (or both) with respect to a main droplet.

Droplets are typically detected using optical metrology equipment. One problem with using optical metrology equipment to detect droplets is the fact that the satellite droplets tend to be much smaller than the main droplets. Since it is desirable to position the optical metrology equipment some safe distance from the plasma generated by the aforementioned irradiation using laser pulses, typical optical instruments in the irradiation chamber may not have sufficient resolution to detect these satellite droplets. In some cases, the satellite droplets may be very close in physical proximity to the main droplet in the droplet stream, making detection via optical metrology even more difficult.

In accordance with an embodiment of the invention, satellite droplet detection is accomplished by analyzing the temporal shape of the laser pulses (such as the CO₂ laser pulses) of the laser beam (such as preferably the main drive beam) configured in the NOMO (no master oscillator) configuration. The inventor herein recognizes that in the NOMO configuration, the drive laser pulses on every droplet and micro-droplet in the pulse stream. In an example, a fast photo-detector, preferably fast enough to resolve nanosecond pulses, is employed to sense the reflected laser beam (such as the main drive beam). The reflected CO₂ beam may represent the reflection of the CO₂ beam on internal lenses of a final focus module or on other surfaces. In an example, a fast IR photo-detector is employed.

By sensing the reflected drive laser beam, no disturbance is made to the drive laser beam employed to irradiate the droplet material. Advantageously, beam control and efficiency is maximized. Further, information about the satellite droplets can be obtained at multiple possible locations in the chamber (since reflection tends to be more than uni-directional, unlike the point-to-point nature of the laser beam itself). In one or more embodiments, the reflected drive laser beam can be sampled from the laser window (such as the window into the chamber), for example. This increases flexibility with respect to where and how to acquire the reflected drive laser beam information.

The signal from the photo-detector may then be displayed on a fast oscilloscope (e.g., 500 MHz or faster to resolve nanosecond pulses) for visual detection of the satellite droplets. Alternatively or additionally, digital processing techniques may be employed on the signal from the photo-detector to detect the presence of satellite droplets.

In another embodiment, the EUV radiation pulses (instead of the temporal features of the reflected CO₂ beam) may be analyzed to detect EUV pulse spikes indicative of the presence of satellite droplets. In an embodiment, the EUV radiation pulses are analyzed and if there exist extra pulses outside of the envelopes of pulses that correspond with the irradiation of the main droplets, these extra EUV pulses may indicate the presence of satellite droplets.

This EUV radiation pulse spike approach has, in an embodiment, the advantage of re-using metrology equipment that is often already present in the chamber for other purposes. In an example, the EUV controller may time-stamp each pulse. The intervals between the expected main pulses may be analyzed for the presence of signal peaks indicative of satellite droplets. For example, a distribution plot may be generated for all the pulses. Peaks that exist outside of the envelopes of peaks representing the main droplet pulse firings (e.g., in the interval between envelope of peaks representing the main pulse firings) may indicate that satellite droplets exist.

The features and advantages of embodiments of the invention may be better understood with reference to the figures and discussions that follow.

FIG. 7 shows an example of NOMO temporal pulse wherein the micro-droplets coalesce into the main droplets in the absence of satellite droplets. A main droplet 702 is shown, along with the main droplet pulse envelope 704, representing the set of peaks output by the photo-detector signal. The photo-detector is positioned to monitor the reflection of the drive laser beam, e.g., off lens surfaces or other internal surfaces in the chamber. The main droplet pulse envelope 704 is acquired when main droplet 702 is irradiated by the main pulse of the drive laser beam. Note that due to the operation in the NOMO configuration, the main pulse is often highly modulated and often results in a series of peaks, the reflections of which are captured as peaks 706a, 706b, 706c. These reflection peaks are not indicative of satellite droplets. In a typical case, these peaks within the main droplet pulse envelope may be separated from one another by a time interval in the 20-100 nanoseconds (ns) range. On the other hand, if the main droplets are formed at 40 MHz, for example, the main droplet pulse envelopes will be 250 microseconds (μs) apart.

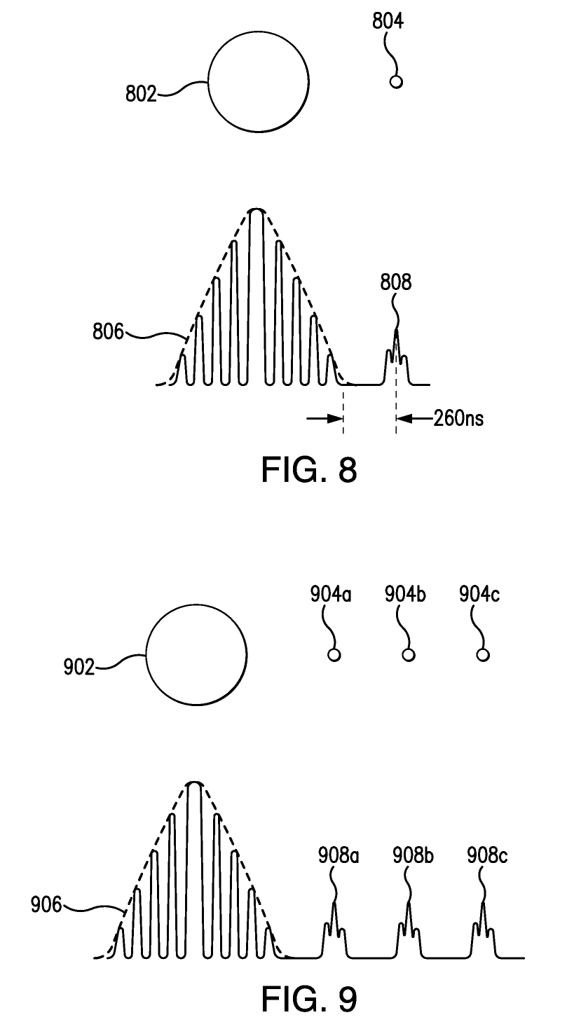

FIG. 8 shows an example of NOMO temporal pulse train wherein the micro-droplets coalesce into a main droplet 802 and a satellite droplet 804. FIG. 8 shows an example scenario wherein the micro-droplets coalesce into a main droplet 802 and a satellite droplet 804 remains. It is of note that satellite droplet 804 is essentially undetectable using optical metrology (often the case when the satellite droplet is behind the main droplet). Main droplet pulse envelope 806 represents the set of peaks output by the photo-detector corresponding to the irradiation of main droplet 802, and non-conformal peak 808 represents the peak or set of peaks output by the photo-detector corresponding to the irradiation of satellite droplet 804.

Non-conformal peak 808 is separated from the edge of the main droplet pulse envelope 806 by about 260 ns in this example, which is substantially longer than the 20-100 ns separation of the sub-peaks within main droplet pulse envelope 806. Even if the satellite droplet is closer to the main droplet in the droplet stream (and thus the separation is less than the aforementioned 260 ns example), this non-conformal peak 808 still occurs outside of main droplet pulse envelope 806 and may be detected by performing signal processing on the photo-detector signal.

FIG. 9 shows an example of NOMO temporal pulse train wherein the micro-droplets coalesce into a main droplet 902 and a plurality of satellite droplets 904a, 904b, and 904c. As with the example of FIG. 8, satellite droplets 904a, 904b, and 904c are essentially undetectable using optical metrology. Main droplet pulse envelope 906 represents the set of peaks output by the photo-detector corresponding to the irradiation of main droplet 902, and non-conformal peaks 908a, 908b, and 908c represent the peaks or sets of peaks output by the photo-detector corresponding to the irradiation of satellite droplets 904a, 904b, and 904c respectively.

Non-conformal peaks 908a, 908b, and 908c are outside of main droplet pulse envelope 806 and are separated from one another by about 355 nanoseconds (ns) in the example of FIG. 9. By performing signal processing that looks for extraneous peaks outside of the main droplet pulse envelopes (which occur at known intervals such as 250 μs for a 40 KHz main droplet rate), the presence of these peaks 908a, 908b, and 908c can be detected. Example of such signal processing includes detecting reflections of the drive laser beam that match the signature of satellite droplet lasing, box car integration of the signal obtained from the photo-detector, visual inspection of the signal obtained from the photo-detector using a fast oscilloscope, comparing the signal obtained from the photo-detector against a “golden” reference signal that is known to be free of satellite droplet lasing.

In another embodiment, the EUV radiation pulses (instead of the temporal features of the reflected CO₂ beam) may be analyzed to detect EUV pulse spikes indicative of the presence of satellite droplets. As the droplets (either main droplets or satellite droplets) are irradiated, EUV pulses are generated. In an embodiment, the train of EUV radiation pulses is analyzed and if there exist extra pulses outside of the envelopes of pulses that correspond with the irradiation of the main droplets, these extra EUV pulses may indicate the presence of satellite droplets.

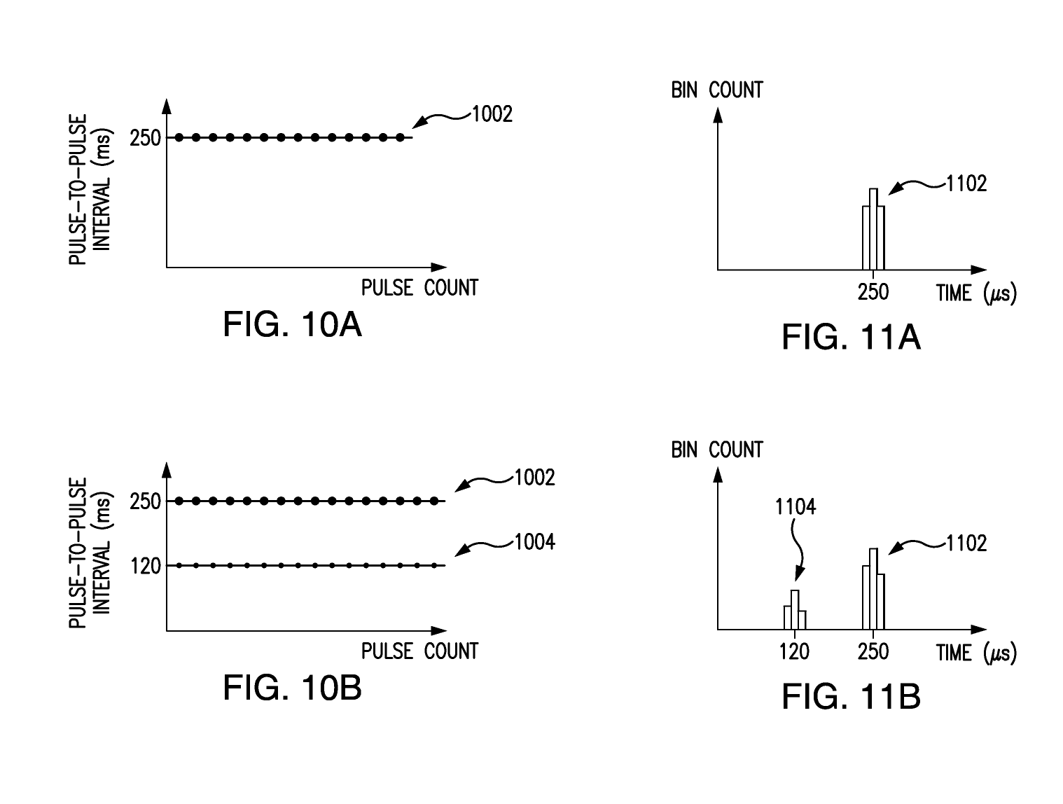

FIG. 10A shows an example plot of EUV pulse-to-pulse interval (Y axis) versus pulse count (X axis). In this example, the main droplets are irradiated at 40 MHz and if there are no satellite droplets, the plot shows EUV pulses separated from one another at 250 μs interval (shown in FIG. 10A by the train of pulses 1002).

FIG. 10B shows an example plot of EUV pulse-to-pulse interval (Y axis) versus pulse count (X axis) for the situation where there are satellite droplets in addition to the main droplets in the droplet stream. The lasing of these satellite droplets results in 120 μs pulse-to-pulse interval in this example. This is shown in FIG. 10B by the train of pulses 1004. The train of pulses 1002 corresponding to the lasing of the main droplets is also shown.

FIG. 11A shows the histogram plot for the example of FIG. 10A where no satellite droplets exist. The Y axis represents the bin count, and the X axis represents the time (in microseconds) between droplets. A well-defined set of peaks 1102 clustered around the 250 μs mark represents the EUV pulses detected at around the 250 μs interval.

FIG. 11B shows the histogram plot for the example of FIG. 10B where satellite droplets are detected at 120 μs interval. The set of peaks 1104 clustered around the 120 μs mark indicates the presence of non-conformal EUV pulses, corresponding to the lasing of the satellite droplets and the EUV pulses generated from the satellite droplet lasing.

Generally speaking, the EUV pulses corresponding to satellite droplet lasing can be detected using any signal processing technique that detects in the output EUV pulse train the extra EUV pulses that occur outside the clusters of EUV pulses corresponding to the lasing of the main droplets. For example, the output EUV pulse train can be compared to a “golden” reference EUV pulse train that that is known to be free from satellite droplet lasing to detect the occurrence of the extra EUV peaks corresponding to satellite droplet lasing. As another example, a boxcar integration approach can be employed on the EUV pulse train to detect the EUV pulses corresponding to satellite droplet lasing.

This EUV radiation pulse spike approach has the advantage of using metrology equipment that is often already present in the chamber for other purposes. In an example, the EUV controller may time-stamp each pulse. The intervals between the expected main pulses may be analyzed for the presence of signal peaks indicative of satellite droplets. For example, a distribution plot may be generated for all the EUV pulses. Peaks that exist outside of the envelopes of peaks representing the main pulse firings (e.g., in the interval between envelope of peaks representing the main pulse firings) may indicate that satellite droplets exist.

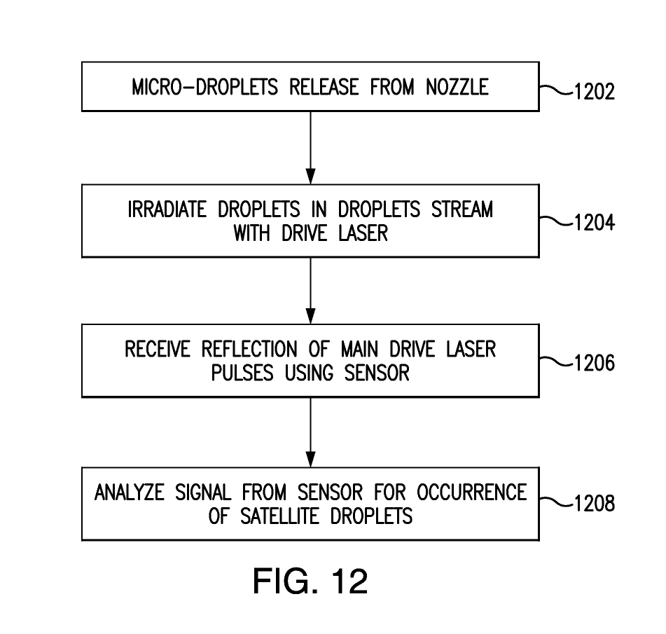

FIG. 12 shows, in accordance with an embodiment of the invention, a method for detecting satellite droplets using reflection of the main drive laser beam. In step 1202, the micro-droplets are released from the droplet generation arrangement, such as from the nozzle. By using an appropriate modulation signal, the micro-droplets are made to coalesce into main droplets in the droplet stream. In step 1204, the main drive laser (such as a CO₂ laser) is activated to irradiate the droplets in the droplet stream. In a preferred example, the drive laser system is configured in the NOMO (No Master Oscillator) configuration.

In step 1206, reflection from the main drive laser pulsing is received using a sensor, such as a photo-detector which may be, in an embodiment, an IR (Infrared) photo-detector. In step 1208, the output signal from the photo-detector is analyzed for the occurrence of satellite droplet lasing. Analysis may employ any suitable signal processing technique, as discussed earlier.

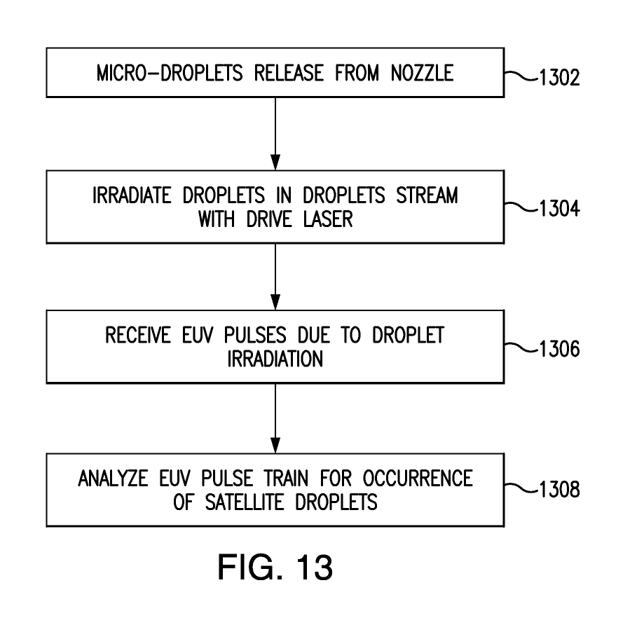

FIG. 13 shows, in accordance with an embodiment of the invention, a method for detecting satellite droplets using EUV peak detection. In step 1302, the micro-droplets are released from the droplet generation arrangement, such as from the nozzle. By using an appropriate modulation signal, the micro-droplets are made to coalesce into main droplets in the droplet stream. In step 1304, the main drive laser (such as a CO₂ laser) is activated to irradiate the droplets in the droplet stream. In a preferred example, the drive laser system is configured in the NOMO (No Master Oscillator) configuration.

In step 1306, the EUV pulses generated when the droplets in the droplet stream are irradiated are then recorded as a pulse train or a signal representing such pulse train. In step 1308, the signal representing the pulse train generated when the droplets in the droplet stream are irradiated is analyzed for the occurrence of satellite droplet lasing. Analysis may employ any suitable signal processing technique, as discussed earlier.

If it is ascertained that satellite droplets exist, remedial action may be taken to reduce or eliminate satellite droplets from the droplet stream. For example, the modulation signal that modulates the nozzle may be tuned to reduce or eliminate the satellite droplets from the droplet stream. Tuning may include modifying one or more parameters of the modulation signal, including for example changing the frequency/frequencies, amplitude, relative position of rising edge, relative position of lowering edge, relative amplitude of the rising edge, relative amplitude of the lowering edge, etc.

As another example, maintenance may be performed on the droplet generation system (such as nozzle cleaning or replacement). In an embodiment, the satellite droplets may be monitored in-situ while the photolithographic system is in its production operating mode or during post-production analysis. In an embodiment, the presence and/or quantity of satellite droplets in the droplet stream may be used as a signal to indicate the health of the droplet generation system, enabling system operator to perform tuning and/or maintenance when needed.

While the particular embodiments) described and illustrated in this Patent Application in the detail required to satisfy 35 U.S.C. §112 are fully capable of attaining one or more of the above-described purposes for, problems to be solved by, or any other reasons for, or objects of the embodiment(s) above-described, it is to be understood by those skilled in the art that the above-described embodiment(s) are merely exemplary, illustrative and representative of the subject matter which is broadly contemplated by the present application. Reference to an element in the following Claims in the singular, is not intended to mean nor shall it mean in interpreting such Claim element “one and only one” unless explicitly so stated, but rather “one or more”. All structural and functional equivalents to any of the elements of the above-described embodiment(s) that are known, or later come to be known to those of ordinary skill in the art, are expressly incorporated herein by reference and are intended to be encompassed by the present Claims. Any term used in the Specification and/or in the Claims and expressly given a meaning in the Specification and/or Claims in the present Application shall have that meaning, regardless of any dictionary or other commonly used meaning for such a term. It is not intended or necessary for a device or method discussed in the Specification as an embodiment to address or solve each and every problem discussed in this Application for it to be encompassed by the present Claims. No element, component, or method step in the present disclosure is intended to be dedicated to the public regardless of whether the element, component, or method step is explicitly recited in the Claims. No claim element in the appended Claims is to be construed under the provisions of 35 U.S.C. §112, sixth paragraph, unless the element is expressly recited using the phrase “means for” or, in the case of a method claim, the element is recited as a “step” instead of an “act”.

1. A system for producing EUV light, comprising:
a material delivery system for producing a stream of material droplets;
a laser system for producing a drive laser beam, the drive laser beam is configured to irradiate the material droplets at an irradiation point;
a monitoring system for monitoring at least one of drive laser beam reflection from the drive laser beam and EUV radiation pulses, the monitoring system producing a detector signal responsive to the monitoring the drive laser beam reflection if the reflection from the drive laser beam is monitored or responsive to the monitoring the EUV radiation pulses if the EUV radiation pulses are monitored, the detector signal being a pulse train; and
arrangement for analyzing the detector signal to ascertain whether there exists at least one satellite droplet in the stream of material droplets.

2. The system of claim 1 wherein the stream of material droplets comprise of main droplets having a first droplet size and satellite droplets having a second droplet size smaller than the first droplet size.

3. The system of claim 1 wherein the material delivery system comprises arrangement to modulate a disturbance signal configured to produce the stream of material droplets wherein the droplets are formed at a predefined rate and wherein the main droplets represent droplets formed the predefined rate.

4. The system of claim 3 wherein the satellite droplet represents a droplet formed at a rate different from the predefined rate relative to the main droplets of the stream of material droplets.

5. The system of claim 1 wherein the monitoring system monitors the drive laser beam reflection and wherein the detector represents an IR detector.

6. The system of claim 5 wherein the drive laser beam reflection is obtained from at least one internal surface in the chamber.

7. The system of claim 1 wherein the laser system is configured in the NOMO mode.

8. The system of claim 1 wherein the monitoring system monitors the EUV radiation pulses.

9. The system of claim 1 wherein the arrangement for analyzing the detector signal represents a digital signal processing system.

10. The system of claim 1 wherein the arrangement for analyzing the detector signal is configured to detect a signal peak that occurs outside envelopes of signal peaks representative of main droplet pulses.

11. A system for producing EUV light, comprising:
a material delivery system for producing a stream of material droplets;
a laser system for producing a drive laser beam, the drive laser beam is configured to irradiate the material droplets at an irradiation point;
a detector arrangement for monitoring EUV radiation pulses, the detector producing a detector signal responsive to the monitoring the EUV radiation pulses, the detector signal being a pulse train; and
arrangement for analyzing the detector signal to ascertain whether there exists at least one satellite droplet in the stream of material droplets.

12. The system of claim 11 wherein the stream of material droplets comprise of main droplets having a first droplet size and satellite droplets having a second droplet size smaller than the first droplet size.

13. The system of claim 11 wherein the material delivery system comprises arrangement to modulate a disturbance signal configured to produce the stream of material droplets wherein the droplets are formed at a predefined rate and wherein the main droplets represent droplets formed the predefined rate.

14. The system of claim 13 wherein the satellite droplet represents a droplet formed at a rate different from the predefined rate relative to the main droplets of the stream of material droplets.

15. The system of claim 11 wherein the laser system is configured in the NOMO mode.

16. The system of claim 11 wherein the arrangement for analyzing the EUV radiation pulses is configured to detect a signal peak that occurs outside envelopes of signal peaks representative of main droplet pulses.

17. A system for producing EUV light, comprising:
a material delivery system for producing a stream of material droplets;
a laser system for producing a drive laser beam, the drive laser beam is configured to irradiate the material droplets at an irradiation point;
a detector for monitoring drive laser beam reflection from the drive laser beam, the detector producing a detector signal responsive to the monitoring the drive laser beam reflection, the detector signal being a pulse train; and
arrangement for analyzing the detector signal to ascertain whether there exists at least one satellite droplet in the stream of material droplets.

18. The system of claim 17 wherein the stream of material droplets comprise of main droplets having a first droplet size and satellite droplets having a second droplet size smaller than the first droplet size.

19. The system of claim 17 wherein the material delivery system comprises arrangement to modulate a disturbance signal configured to produce the stream of material droplets wherein the droplets are formed at a predefined rate and wherein the main droplets represent droplets formed the predefined rate.

20. The system of claim 17 wherein the satellite droplet represents a droplet formed at a rate different from the predefined rate relative to the main droplets of the stream of material droplets.

21. The system of claim 17 wherein the laser system is configured in the NOMO mode.
